(19) United States
(12) Patent Application Publication
(10) Pub. No.: US 2026/0055212 A1
(43) Pub. Date: Feb. 26, 2026

(54) POLYCONDENSATION OF SUGARS IN THE PRESENCE OF WATER USING A MICROREACTOR

(71) Applicants: Cargill, Incorporated, Wayzata, MN (US); Karlsruher Institut Für Technologie, Karlsruhe (DE)

(72) Inventors: Sara Claramunt-Carbonell, Heidelberg (DE); Andreas Hensel, Karlsruhe (DE); Manfred Kraut, Karlsruhe (DE); Bruno Frédéric Stengel, Brussels (BE)

(73) Assignees: Cargill, Incorporated, Wayzata, MN (US); Karlsruher Institut Für Technologie, Karlsruhe (DE)

(21) Appl. No.: 19/102,874

(22) PCT Filed: Aug. 9, 2023
(86) PCT No.: PCT/US2023/071922

§ 371 Date: Feb. 11, 2025

(30) Foreign Application Priority Data
Aug. 12, 2022 (EP) 22190222.4

(51) Int. Cl. C08B 37/00; A23C 9/152; A23G 3/42

(52) U.S. Cl. CPC C08B 37/006; A23C 9/152; A23G 3/42

(57) ABSTRACT

The present invention relates to a polysaccharide and methods of making the polysaccharide. In particular, the present invention relates to polysaccharides having physical properties which are desirable in, at least, food and beverage products. In particular, the present invention relates to methods of making polysaccharides having physical properties that are desirable in, at least, food and beverage products.

### CROSS-REFERENCE TO RELATED APPLICATIONS

This application claims the benefit of European Application No. 22190222.4, filed Aug. 12, 2022, which is incorporated by reference herein in its entirety.

### FIELD OF THE INVENTION

The present invention relates to a polysaccharide and methods of making the polysaccharide. In particular, the present invention relates to polysaccharides having physical properties which are desirable in, at least, food and beverage products. In particular, the present invention relates to methods of making polysaccharides having physical properties that are desirable in, at least, food and beverage products.

### BACKGROUND OF THE INVENTION

Carbohydrates are found in an array of food and beverage products, such as processed cereal, soft drinks, bread, beans, potatoes, corn, and pasta. The carbohydrates present in the food and beverage products come in a variety of forms, the most common of which are sugars, fibres and starches. The fibres found in food products are commonly known as dietary fibres, which are present in, but not limited to being present in, vegetables, fruits, whole grains and legumes. Dietary fibres are the indigestible part of food and beverages originating from plants and typically pass relatively intact through the digestive system and out of the consumer's body.

Dietary fibres can be split into two forms: soluble dietary fibres and insoluble dietary fibres. Most food and beverage products, especially those originating from plants, contain both soluble and insoluble dietary fibres, in varying amounts. Soluble dietary fibres dissolve in water and may form a gel-like material. Examples of fruits, grains and vegetables containing soluble dietary fibres include, but are not limited to, oats, peas, beans, apples, citrus fruits, carrots and barley. Insoluble dietary fibres are traditionally used in food and beverage products to provide desirable characteristics, such as nutrition, texture and/or mouthfeel. Insoluble dietary fibres promote the movement of material through a consumer's digestive system as well as increasing stool bulk. Examples of food and beverage products containing insoluble dietary fibres include, but are not limited to, whole-wheat flour, wheat bran, nuts, beans and vegetables such as cauliflower, green beans and potatoes.

There is an interest in developing ingredients that are suitable for use in food products, wherein the ingredients enhance the dietary fibre content or reduce the caloric content of the food. These ingredients may also have certain health benefits, in particular in light of the worldwide obesity epidemic. Obesity is an important risk factor for diseases such as type 2 diabetes and cardiovascular diseases, which are already a leading cause of death in many countries. There is therefore a need for ingredients which can enhance the dietary fibre content or reduce the caloric content of food. Soluble dietary fibres can be used to modify the texture, thickness, mouthfeel, body or other physical characteristics of a food or beverage product. An example of soluble dietary fibres includes polysaccharides such as polydextrose and resistant dextrins.

Typically, polydextrose is formed by polymerisation of sugar monomers. The resultant polydextrose contains a highly branched polymer that is difficult for human enzymes to digest: polydextrose is only partially metabolized by the microbiome in the human intestine. Hence, polydextrose is not digestible, or only digestible to a limited extent, by a human body. As a consequence of polydextrose not being digested in the digestive system, polydextrose is of interest in products used in food and beverage products.

Typically, resistant dextrins are formed by the polymerization of sugar monomers. Resistant dextrins are short chain glucose polymers typically obtained by high-temperature acidification of starch. The resultant resistant dextrin contains α-1,2 and α-1,3 glycosidic bonds in addition to the existing α-1,4 and α-1,6 glycosidic bonds which are also present in starch. The resistant dextrins also contain reducing terminals that may contain β-1,6 glycosidic bonds. The α-1.2, α-1,3 and α-1,6 glycosidic bonds cannot be decomposed by various digestive enzymes in the human body, and therefore cannot be digested and absorbed by the small intestine after entering the human digestive tract. Hence, resistant dextrins are not digestible, or only digestible to a limited extent, by a human body. As a consequence of resistant dextrins not being digested in the digestive system, resistant fibres are of interest in products used in food and beverage products. Examples of resistant dextrins used in food and beverage products are described in WO2013015890A1, U.S. Pat. No. 10,988,550B2 and EP3409693B1.

One reason why soluble dietary fibres are of interest to the food and beverage industry is because they can be used to enhance dietary fibre content and/or reduce the sugar and caloric content of the food or beverage. These modifications are important for the health benefit deriving from the resultant food or beverage product. For example, as a consequence of the soluble dietary fibres not being absorbed in the small intestine, the soluble dietary fibres can enter the large intestine and be used by various probiotics as nutrients to achieve various physiological functions of dietary fibres. A second example is that the soluble dietary fibres can also be used to create a feeling of satiety owing to the soluble dietary fibres not being absorbed, thus soluble dietary fibres can be used as a good base material in food products for people with obesity. A third example is that the soluble dietary fibres can also be used to replace higher calorie content in food and beverage products, such as food and beverage products that contain a high level of sugar (such as sucrose).

There is a continued need for improved polysaccharides that can be used in food and/or beverage products.

Traditionally, polysaccharides such as polydextrose or resistant dextrins were produced by the polycondensation of glucose in a continuous stirred tank reactor (CSTR). Typically, the glucose is provided in aqueous form. One disadvantage of the traditional method is that before the actual polycondensation occurs, most of the water needs to be removed by vacuum distillation which occurs at a temperature of from 110 to 130° C., preferably 120° C. This step alone can take one to two hours to complete at 120° C. before polycondensation can be initiated by the addition of a catalyst. Together with catalyst addition, the temperature is raised to a temperature of 145° C. or greater. There is therefore much interest in improving the method for producing polysaccharides.

One way of improving the method of producing polysaccharides is to use a microreactor, as described in WO2011091962A1. The method requires the following steps:
1. the provision of a dry blend of a sugar, such as glucose or dextrose (in the production of polydextrose, sorbitol and citric acid are also provided);
2. mixing the dry blend from step 1 with water at 80° C. to obtain a solution at 80 weight % solids content;
3. pumping the mixture from step 2 at a rate of 20 ml/min through a first microreactor, wherein the mixture was brought to a temperature of 200° C.;
4. spraying the products from the first microreactor into a collection chamber to dry by flash evaporation;
5. pumping the products from step 4 at a rate of 20 ml/min through a second microreactor, wherein the mixture was brought to a temperature of 200° C.; and
6. diluting with water the product from step 5 to 50 weight % solids content, wherein the product contained 80 weight % polymerisation products.

The microreactors traditionally used are typically stacks of machined or etched metallic foils that are fused into a block by diffusion welding. The foils comprise of linear or curved, parallel channels. The channels can be square, rectangular, circular, elliptical, or, semi-elliptical in shape. Depending on the design of the foils, crossflow, or, counter-current flow of the media within the microreactors can be achieved.

There is a continued need for an improved method for producing polysaccharides that can be used in food and/or beverage products.

### SUMMARY

The present invention relates to a polysaccharide and methods of making the polysaccharide. In particular, the present invention relates to polysaccharides having physical properties which are desirable in, at least, food and beverage products. In particular, the present invention relates to methods of making polysaccharides having physical properties that are desirable in, at least, food and beverage products.

Representative features of the present invention are set out in the following clauses, which stand alone or may be combined, in any combination, with one or more features disclosed in the text of the specification.

The present invention is as set out in the following clauses:

1. A polysaccharide comprising:
from 5 to 35 weight % of 1,2-glycosidic linkages and 1,3-glycosidic linkages,
from 25 to 35 weight % of 1,4-glycosidic linkages, and
from 35 to 45 weight % of 1,6-glycosidic linkages,
wherein the polysaccharide has a DP1 and a DP2 content, wherein DP1 and DP2 are present at a combined weight % of from greater than 15 weight % to 25 weight %.

2. The polysaccharide of clause 1, wherein DP1 and DP2 are present at a combined weight % of from greater than 15 weight % to 25 weight %, or, from greater than 17.5 weight % to 22.5 weight %, or, at 20 weight % wherein the weight % is measured on dry basis.

3. The polysaccharide of clause 1 or clause 2, wherein the polysaccharide has a DP1+content of from 90 to 99 weight %, or, from 92 to 96 weight %, or, 93.6 weight %, wherein the weight % is measured on dry basis.

4. The polysaccharide of any one of clauses 1 to 3, wherein the polysaccharide has a DP1 content of from 2 to 5 weight %, or, from 3 to 4 weight %, or, 3.5 weight %, wherein the weight % is measured on dry basis.

5. The polysaccharide of any one of clauses 1 to 4, wherein the polysaccharide comprises 1,6-anhydrous dextrose at from 1 to 4 weight %, or, from 2 to 3 weight %, or, at 2.4 weight %, wherein the weight % is measured on dry basis

6. The polysaccharide of any one of clauses 1 to 5, wherein the polysaccharide has a DPn content, wherein n is equal to 8 or higher, wherein DPn is present at 55 weight % or less, or, 50 weight % or less wherein the weight % is measured on dry basis.

7. The polysaccharide of any one of clauses 1 to 6, wherein the polysaccharide has a DP3 to DP7 content, wherein the DP3 to DP7 are present at a combined weight % of from 28 to 45 weight %, or, from 29 to 35 weight %.

8. The polysaccharide of any one of clauses 1 to 7, wherein the polysaccharide comprises, or consists of, glucose monomers.

9. The polysaccharide of clause 8, wherein the polysaccharide comprises from 50 to 100 weight % glucose monomers, or, from 60 to 100 weight % glucose monomers, or, from 70 to 100 weight % glucose monomers, or, from 80 to 100 weight % glucose monomers, or, from 90 to 100 weight % glucose monomers, or, 100 weight % glucose monomers.

10. The polysaccharide of any one of clauses 1 to 9, wherein the polysaccharide has a fibre content of from 70 to 85 weight %, or, from 75 to 80 weight %, or, 77 weight %.

11. The polysaccharide of any one of clauses 1 to 10, wherein the polysaccharide has a 5-hydroxymethylfurfural (HMF) content of less than 5 ppm, or, less than 4 ppm, or, less than 3 ppm, or, less than 2.5 ppm, or, 2 ppm.

12. The polysaccharide of any one of clauses 1 to 11, wherein the polysaccharide has a furfural content of less than 5 ppm, or, less than 4 ppm, or, less than 3 ppm, or, less than 2.5 ppm, or, 2 ppm.

13. The polysaccharide of any one of clauses 1 to 12, wherein the polysaccharide has a Gardner colorimetric value of less than 2, or, less than 1.5, or, less than 1.25, or, less than 1.1, or, less than 1.05, or, less than 1.0, or, less than 0.9, or, preferably 0.8.

14. The polysaccharide of any one of clauses 1 to 13, wherein the polysaccharide has a pH of from 4 to 6, or, from 4.5 to 5.5, or, 5.1.

15. The polysaccharide of any one of clauses 1 to 14, wherein the polysaccharide is a polydextrose and/or a resistant dextrin.

16. A composition comprising:

the polysaccharide of any one of clauses 1 to 15; and water.

17. The composition of clause 16, wherein the composition comprises dry solids at from 40 to 90 weight %, or, from 45 to 80 weight %.

18. The composition of clause 17, wherein the dry solids comprises, or consists of, the polysaccharide.

19. A method for making the polysaccharide according to any one of clauses 1 to 15, the method comprising:
(a) providing a saccharide feed comprising glucose monomers and/or glucose oligomers;
(b) providing at least one acid catalyst;
(c) providing a microreactor comprising one or more flow guiding elements; and
(d) passing the saccharide feed through the microreactor in the presence of the acid catalyst until at least 80 weight % of the glucose monomers and/or glucose oligomers in the saccharide feed have reacted to form a polysaccharide having a DPn content, wherein n is at least 3.

20. The method of clause 19, where the saccharide feed comprises a dry substance content of less than 80 weight %, or, less than 70 weight %, or, less than 60 weight %.

21. The method of clause 20, wherein the remaining weight % of the saccharide feed is water.

22. The method of clause 20 or clause 21, wherein the dry substance content comprises the glucose monomers and/or glucose oligomers at from at least 50 weight %, or, at least 55 weight %, or, at least 60 weight %.

23. The method of any one of clauses 20 to 22, wherein the dry substance content comprises:
monosaccharides, disaccharides and oligosaccharides from at most 50 weight %, or,
at most 45 weight %, or, at most 40 weight %; and
wherein the monosaccharides, disaccharides and oligosaccharides do not include glucose monomers and/or glucose oligomers.

24. The method of any one of clauses 19 to 23, wherein at least 85 weight %, or, at least 90 weight %, or, at least 95 weight % of the glucose monomers and/or glucose oligomers in the saccharide feed react to form a polysaccharide having a DPn content, wherein n is at least 3.

25. The method of any one of clauses 19 to 24, wherein the microreactor operates at a temperature of from 180 to 250° C., or, from 190 to 245° C., or, from 200 to 240° C., or, from 220 to 235° C. or, 220° C.

26. The method of any one of clauses 19 to 25, wherein the microreactor operates at a pressure of from 2 to 25 bar, or, from 2 to 20 bar, or, from 2 to 15 bar, or, from 2 to 10 bar, or, from 2 to 5 bar, or, from 2 to 3 bar.

27. The method of any one of clauses 19 to 26, wherein the saccharide feed has a residence time in the microreactor of 180 seconds or less, or, 120 seconds or less, or, 100 seconds or less, or, 90 seconds or less, or, 80 seconds or less, or, 70 seconds or less, or, 60 seconds or less, or, 50 seconds or less, or, at least 5 seconds, or, at least 10 seconds, or, at least 15 seconds.

28. The method of any one of clauses 19 to 27, wherein the glucose monomers and/or glucose oligomers have a DPn content, wherein n has an average value of from 3 to 10.

29. The method of any one of clauses 19 to 28, wherein the glucose monomers and/or glucose oligomers are sourced from a glucose syrup or a maltodextrin.

30. The method of clause 29, wherein the glucose syrup has a dextrose equivalent (DE) of 20 or greater.

31. The method of clause 29, wherein the maltodextrin has a dextrose equivalent (DE) of from 3 to 20.

32. The method of any one of clauses 19 to 31, wherein the saccharide feed comprises a polyol.

33. The method of clause 32, wherein the polyol is any one of glycerol, erythritol, threitol, arabinitol, xylitol, ribitol, allitol, altritol, gulitol, galactitol, mannitol, sorbitol, talitol, maltitol, isomaltitol, isomalt, lactitol, or, a combination thereof.

34. The method of any one of clauses 19 to 33, wherein the acid catalyst is any one of phosphoric acid, citric acid, malic acid, succinic acid, adipic acid, gluconic acid, tartaric acid, fumaric acid, or, a combination thereof.

35. The method of any of clauses 32 to 34, wherein the polyol is sorbitol and the acid catalyst is any one of phosphoric acid, citric acid, malic acid, succinic acid, adipic acid, gluconic acid, tartaric acid, fumaric acid, or, a combination thereof.

36. The method of any one of clauses 32 to 35, wherein the saccharide feed comprises the glucose monomers and/or glucose oligomers, polyol and acid catalyst in the weight ratio of from 85:15:1 to 95:5:1 respectively.

37. The method of any one of clauses 32 to 35, wherein the saccharide feed comprises the glucose monomers and/or glucose oligomers, polyol and acid catalyst in the weight ratio of 90:10:1 respectively.

38. The method of any one of clauses 19 to 37, wherein the microreactor comprises a plurality of flow guiding elements; optionally. 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or, 50 flow guiding elements, or more depending on the size of each flow guiding element.

39. The method of clause 38, wherein the plurality of flow guiding elements are arranged: in series; or, in parallel; or, a portion of the plurality are in a first series, a portion of the plurality are in a second series and the first series and the second series are in parallel.

40. The method of any one of clauses 19 to 39, wherein:
the flow guiding element is a device for achieving a defined guidance of a volume of a flow of a fluid through a channel-shaped element;
wherein in the channel shaped element microchannel structural flow guide elements are arranged for dividing the volume flow and for guidance of the resulting partial flows of fluids;
wherein the construction is arranged in such a way that the partial streams are guided such that they are brought into contact alternatively with the inner wall of the channel-shaped elements and with the other partial streams.

41. The method of clause 40, wherein the cross section of the channel-shaped element is designed in a circular, circular-ring, elliptical, or, rectangular shape.

42. The method of clause 40 or clause 41, wherein the flow guiding elements comprise a catalytically active material; optionally,
wherein the microchannel structured flow guide elements further comprises a support material to which the catalytically active material is supported; optionally,
wherein the support material is carbon or silica.

43. The method of clause 42, wherein the catalytically active material is an acid.

44. The method of clause 43, wherein the acid is any one of phosphoric acid, citric acid, malic acid, succinic acid, adipic acid, gluconic acid, tartaric acid, fumaric acid, or, a combination thereof.

45. The method of any one of clauses 40 to 44, wherein the microchannel structured flow guide elements comprise a catalytically active material, a corrosion protection material, an antifouling layer, or, a combination thereof; optionally,
wherein the microchannel structured flow guide elements further comprises a support material to which the catalytically active material, a corrosion protection material, an antifouling layer, or, a combination thereof Is supported; optionally,
wherein the support material is carbon or silica.

46. The method of any one of clauses 19 to 45, wherein the method does not comprise a flash evaporation drying step.

47. The method of any one of clauses 19 to 46, wherein the method does not comprise a water reduction step.

48. The method of any one of clauses 19 to 47, wherein the method consists of passing the saccharide feed through the microreactor once.

49. The method of any one of clauses 19 to 48, wherein the method further includes one or more of the following steps: chromatography, hydrogenation, filtration (via ultra or membrane filtration), activated carbon treatment, decolourisation, electrolysis, ion exchange resins, or a combination thereof.

50. A food or beverage product comprising the polysaccharide according to any one of clauses 1 to 15.

51. The food or beverage product of clause 50, wherein the food product is a dairy food product; optionally,
wherein the dairy food product is a milk based drink; or,
wherein the food product is a confectionary food product; optionally, wherein the confectionary food product is gummies, wine gums, gelatine sweets, gum drops or jellybeans.

### DETAILED DESCRIPTION

Embodiments of the invention are described below with reference to the accompanying drawings. The accompanying drawings illustrate various embodiments of systems, methods, and embodiments of various other aspects of the disclosure. Embodiments of the claims may, however, be embodied in many different forms and should not be construed as limited to the embodiments set forth herein.

The words “comprising,” “having,” “containing,” and “including,” and other forms thereof, are intended to be equivalent in meaning and be open ended in that an item or items following any one of these words is not meant to be an exhaustive listing of such item/items or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred systems and methods are now described.

Some of the terms used to describe the present invention are set out below:

“Degree of polymerization” (DP) refers to the number of monomeric units in an oligomer. For example,

DP1 contains one monomeric unit and an example includes, but is not limited to, fructose or glucose. For a further example, DP2 contains two monomeric unit and an example includes, but is not limited to, maltose (which is a glucose polymer of two glucose units).

“Dextrin” refers to low-molecular-weight carbohydrates produced by the hydrolysis of starch or glycogen. The low-molecular-weight carbohydrates are generally mixtures of polymers of D-glucose units linked by α-1,4 or α-1,6 glycosidic bonds. Examples of the methods in which dextrins can be produced from starch include, but are not limited to, (a) enzyme digestion using enzymes such as amylases; or, (b) the application of heat under acidic conditions. Examples of dextrins include, but are not limited to, pyrodextrins, oligomers of dextrins, maltodextrins and cyclodextrins.

“Dextrose equivalent” refers to a measure of the amount of reducing sugars present in a sugar product, expressed as a percentage on a dry basis relative to dextrose.

“Disaccharides” refers to any substance that is composed of two molecules of simple sugars (i.e., monosaccharides) linked to each other. Examples of disaccharides include, but are not limited to, sucrose, lactose and maltose.

“Fibre” refers to a thin, threadlike structure that combines to form animal or plant tissue. Fibre is a type of carbohydrate that the human body cannot digest.

“Flow guiding elements” refers to thin-walled components which are installed in a flow channel (e.g., in a pipe in a pipe heat exchanger). The object of the flow guiding elements is to guide the flow in a channel in such a way that fluid flow is divided into partial flows and these partial flows are alternately guided to the wall of the flow channel. As a result of the alternate guiding, heat exchange processes can take place with the channel walls and/or between the partial flows. A heat exchange takes place resulting in heat being transported through the fluid layer, as a result of a temperature difference between the fluid and the wall of the flow channel.

“Food matrix” refers to a physical domain that contains and/or interacts with specific constituents of food (for example a nutrient), providing functionalities and behaviours which are different to those exhibited by the constituents in isolation or a free state.

“Gardner colorimetric values” refers to a colour system devised to provide a value of the yellowness of a sample. The colour system ranges from 0 to 18. As an example, 1 is light yellow and 18 is dark brown.

“Microreactor” refers to miniaturized reaction vessels fabricated, at least partially, by methods of micro technology and precision engineering. The dimensions of the internal structure of the microreactor's fluid channels (called microchannels here on in) can vary substantially, but typically range from the micrometre to the millimetre range as defined in ISO 10991. Microreactors most often, but not necessarily, are designed with microchannel architecture, and are usually fabricated by methods including, but not limited to, micro machining, precision engineering and 3D printing. These structures contain many channels and each microchannel is used to convert a small amount of material. Free microstructure shapes, not forming dedicated channels, are also possible. Free microstructure shapes can be made by using 3D printing. Several materials such as silicon, ceramics, glass, metals and polymers can be used to construct microreactors.

“Monosaccharides” refers to simple sugars that are made up of from three to seven carbons in either a linear chain or ring-shaped molecules. Examples of monosaccharides include, but are not limited to, glucose, galactose and fructose.

“Particulate form” refers to a combination of one or more particles having a D10 in the range of from 1 to 100 μm, D50 in the range of from 1 to 150 μm and a D90 in the range of from 1 to 300 μm. The particulate form can be homogeneous throughout. Alternatively, the particulate form is not necessarily homogeneous throughout.

“Polysaccharide” refers to a polysaccharide comprising at least from 5 to 35 weight % of 1,2-glycosidic linkages and 1,3-glycosidic linkages, from 25 to 35 weight % of 1,4-glycosidic linkages, and from 35 to 45 weight % of 1,6-glycosidic linkages, wherein the polysaccharide has a DP1 and a DP2 content, wherein DP1 and DP2 are present at a combined weight % of from greater than 15 weight % to 25 weight %.

“Polydextrose” refers to a carbohydrate comprising a highly branched polymer of dextrose monomer units. Polydextrose is only partially metabolized by enzymes present in a human digestive system.

“Repetition length” refers to a distance corresponding to a contact section of a channel wall of a flow guide element. When a partial flow is guided away from the channel wall after contact. The repetition length corresponds to the section of the channel wall where the partial flow was in contact with the channel wall. Further examples of repetition length are included in EP3334993B1, the disclosure of which is hereby incorporated by reference.

“Resistant dextrin” refers to dextrins that are resistant or partially resistant to the digestive enzymes present in the small intestine. Resistant dextrins contain α-1,2 and α-1,3 glycosidic bonds in addition to the α-1,4 and α-1,6 glycosidic bonds, which for example are also present in starch. The resistant dextrin also contains β-1,6 glycosidic bonds. The α-1,3, α-1,2 and α-1,6 glycosidic bonds cannot be decomposed by various digestive enzymes in the human body, contributing to enzyme resistance.

“Weight %” refers to the percentage weight in grams of a component of a composition for every 100 grams of a composition. For example, if a resistant dextrin contained DP1 at 10 weight %, then there is 10 g of DP1 for every 100 g of resistant dextrin.

“Viscosity” refers to the resistance of a fluid (such as a liquid or a gas) to a change in shape.

### Polysaccharides

Polysaccharides formed according to the presently described methods having various desirable properties, which provide an improved polysaccharide for use in food and/or beverage products.

The polysaccharides comprise from 5 to 35 weight % of 1,2-glycosidic linkages and 1,3-glycosidic linkages, from 25 to 35 weight % of 1,4-glycosidic linkages, and from 35 to 45 weight % of 1,6-glycosidic linkages, wherein the weight % is measured on a dry basis. Preferably, the polysaccharides comprise 30 weight % of 1,2-glycosidic linkages and 1,3-glycosidic linkages, 30 weight % of 1,4-glycosidic linkages and 40 weight % of 1,6-glycosidic linkages, wherein the weight % is measured on a dry basis.

The polysaccharides may have a DP1 and DP2 content, wherein DP1 and DP2 are present at a combined weight % of from greater than 15 weight % to 25 weight %, wherein the weight % is measured on dry basis. More preferably, the DP1 and DP2 are present at a combined weight % of from greater than 15 weight % to 25 weight %, or, from greater than 17.5 weight % to 22.5 weight %, or, at 20 weight %, wherein the weight % is measured on a dry basis.

The polysaccharides may have a DP1+content of from 90 to 99 weight %, or, from 92 to 96 weight %, or, 93.6 weight %, wherein the weight % is measured on dry basis.

The polysaccharides may have a DP1 content of from 2 to 5 weight %, or, from 3 to 4 weight %, or, 3.5 weight %, wherein the weight % is measured on dry basis.

The polysaccharides may comprise 1,6-anhydrousdextrose at from 1 to 4 weight %, or, from 2 to 3 weight %, or, at 2.4 weight %, wherein the weight % is measured on dry basis.

The polysaccharides may have a DPn content, wherein n is equal to 8 or higher, wherein DPn is present at 55 weight % or less, or, 50 weight % or less, wherein the weight % is measured on a dry basis.

The polysaccharides may have a DP3 to DP7 content, wherein the DP3 to DP7 are present at a combined weight % of from 28 to 45 weight %, or, from 29 to 35 weight %, wherein the weight % is measured on a dry basis.

The polysaccharides comprise, or consist of, glucose monomers. Preferably, the polysaccharide comprises from 50 to 100 weight % glucose monomers, or, from 60 to 100 weight % glucose monomers, or, from 70 to 100 weight % glucose monomers, or, from 80 to 100 weight % glucose monomers, or, from 90 to 100 weight % glucose monomers, or, from 92 to 100 weight % glucose monomers, or, from 94 to 100 weight % glucose monomers, or, from 90 to 99.9 weight % glucose monomers, or, from 90 to 99.8 weight % glucose monomers, or, 100 weight % glucose monomers, wherein the weight % is measured on a dry basis.

The polysaccharides preferably have a fibre content of from 70 to 85 weight %, or, from 75 to 80 weight %, or, 77 weight %. The fibre content is measured using the well-known method AOAC 2009.01.

The polysaccharides preferably have a 5-hydroxymethylfurfural (HMF) content of less than 5 ppm, or, less than 4 ppm, or, less than 3 ppm, or, less than 2.5 ppm, or, 2 ppm. The polysaccharide preferably has a furfural content of less than 5 ppm, or, less than 4 ppm, or, less than 3 ppm, or, less than 2.5 ppm, or, 2 ppm. The 5-hydroxymethylfurfural (HMF) and furfural content is measured with HPLC equipped with a UV detector.

The polysaccharides preferably have a Gardner colorimetric value of less than 2, or, less than 1.5, or, less than 1.25, or, less than 1.1, or, less than 1.05, or, less than 1.0, or, less than 0.9, or, preferably 0.8. Optionally, the Gardner colorimetric value is measured on a UV/VIS spectrophotometer. The Gardner colorimetric values can be measured using a dual beam Zenon flash spectrometer (for example, a 3nh YS6080 benchtop spectrometer). The spectrometer measures the percentage of transmittance of the product and automatically calculates the Gardner colorimetric parameter.

The polysaccharides preferably have a pH of from 4 to 6, or, from 4.5 to 5.5, or, 5.1.

The polysaccharides are preferably polydextrose and/or resistant dextrin.

### Composition Comprising the Polysaccharide

Another aspect of the present invention relates to a polysaccharide in a composition.

The composition may comprise a polysaccharide and water. Preferably, the composition comprises the polysaccharide as described above. Alternatively, the composition may also be a dried composition of the polysaccharide comprising less than 10 weight % of water, preferably, less than 8 weight % of water, more preferably, less than 5 weight % of water.

The composition may have a dry solids content of from 40 to 90 weight %, or, from 45 to 80 weight %. Preferably, the dry solids content comprises, or consists of, the polysaccharide as described above under the heading “Polysaccharide”. Preferably, the dry solids content comprises, or consists of, the polysaccharide as described above under the heading “Polysaccharide”, sorbitol and glucose wherein the sorbitol is present at less than 2 weight % and the glucose is present at less than 4 weight %. Alternatively, the dry solids content comprises, or consist of, the polysaccharide as described above under the heading “Polysaccharide”, glucose and anhydro-glucose, wherein the glucose is present at less than 5 weight % and the anhydro-glucose is present at less than 4 weight %.

### Method of Producing the Polysaccharide

Another aspect of the present invention relates to a method of making the polysaccharide. The method of making the polysaccharide comprises the steps:
(a) providing a saccharide feed comprising glucose monomers and/or glucose oligomers;
(b) providing at least one acid catalyst;
(c) providing a microreactor comprising one or more flow guiding elements; and
(d) passing the saccharide feed through the microreactor in the presence of the acid catalyst until at least 80 weight % of the glucose monomers and/or glucose oligomers in the saccharide feed have reacted to form a polysaccharide having a DPn content, wherein n is at least 3.

The saccharide feed may comprise a dry substance content of less than 80 weight %, or, less than 70 weight %, or, less than 60 weight %. The remaining weight % of the saccharide feed is a solvent, such as but not limited to, water.

The dry substance content of the saccharide feed may comprise less than 50 weight % of other monosaccharides and oligomers to glucose and glucose oligomers, for instance, fructose and/or fructose oligomers.

The dry substance content of the saccharide feed may comprise glucose and/or glucose oligomers at from at least 50 weight %, or, at least 55 weight %, or, at least 60 weight %.

The dry substance of the saccharide feed may comprise monosaccharides, disaccharides and oligosaccharides at from at most 50 weight %, or, at most 45 weight %, or, at most 40 weight %, wherein the monosaccharides, disaccharides and oligosaccharides do not include glucose monomers and/or glucose oligomers.

By glucose monomers it is meant herein glucose oligomers having a DPn content, wherein n has an average value of from 3 to 10.

The glucose monomers and/or glucose oligomers may be sourced from a glucose syrup. Preferably, the glucose syrup has a DE of 20 or greater. Alternatively, the glucose monomers and/or glucose oligomers may be sourced from maltodextrin. Preferably, the maltodextrin has a dextrose equivalent (DE) of from 3 to 20.

Preferably, at least 85 weight %, or, at least 90 weight %, or, at least 95 weight % of the glucose monomers and/or glucose oligomers in the saccharide feed react to form a polysaccharide having a DPn content, wherein n is at least 3.

Preferably, the microreactor is operating at a temperature of from 180 to 250° C., or, from 190 to 245° C., or, from 200 to 240° C., or, from 220 to 235° C., or at 220° C.

Preferably, the microreactor is operating at a pressure of from 2 to 25 bar, or, from 2 to 20 bar, or, from 2 to 15 bar, or, from 2 to 10 bar, or, from 2 to 5 bar, or, from 2 to 3 bar.

Preferably, the saccharide feed has a residence time in the microreactor of 180 seconds or less, or, 120 seconds or less, or, 100 seconds or less, or, 90 seconds or less, or, 80 seconds or less, or, 70 seconds or less, or, 60 seconds or less, or, 50 seconds or less, or, at least 5 seconds, or, at least 10 seconds, or, at least 15 seconds.

Preferably, the microreactor is operating at a temperature of 220° C., a pressure of from 2 to 3 bar and the saccharide feed and has a residence time in the microreactor of 70 seconds or less.

The saccharide feed may further comprise a polyol. Preferably, the polyol is any one of glycerol, erythritol, threitol, arabinitol, xylitol, ribitol, allitol, altritol, gulitol, galactitol, mannitol, sorbitol, talitol, maltitol, isomaltitol, isomalt, lactitol or a combination thereof. More preferably, the polyol is sorbitol.

Preferably, the acid catalyst is phosphoric acid, citric acid, malic acid, succinic acid, adipic acid, gluconic acid, tartaric acid, fumaric acid, or a combination thereof. Preferably, the acid catalyst is citric acid.

Preferably, the polyol is sorbitol and the acid is phosphoric acid, citric acid, malic acid, succinic acid, adipic acid, gluconic acid, tartaric acid, fumaric acid, or a combination thereof. To prepare polydextrose the polyol is sorbitol and acid is phosphoric acid and/or citric acid.

The saccharide feed may comprise glucose monomers and/or glucose oligomers, polyol and an acid catalyst. Preferably, the saccharide feed comprises the glucose and/or glucose oligomers, polyol and acid catalyst in the weight ratio of from 85:15:1 to 95:5:1. Preferably, the saccharide feed comprises the glucose and/or glucose oligomers, polyol and acid catalyst in the weight ratio of 90:10:1 respectively.

Preferably, the microreactor comprises a plurality of flow guiding elements; optionally, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or, 50 flow guiding elements, or more depending on the size of each flow guiding element. The flow guiding elements can have a repetition length of from 6 mm to 10 mm. The number of partial flows can be 3, 4, or, 5. The microchannels can span 30°, 45°, or, 60°. Preferably, wherein the plurality of flow guiding elements are arranged: in series; or, in parallel; or, a portion of the plurality are in a first series, a portion of the plurality are in a second series and the first series and the second series are in parallel.

The microreactor can be a micro heat exchanger. The micro heat exchanger is a cross flow micro heat exchanger, counter-current flow micro heat exchanger, co-current flow micro heat exchanger or an electrically powered parallel flow micro heat exchanger and/or microreactors suitable for the polycondensation reaction. A cross flow micro heat exchanger is a miniaturized plate heat exchanger in which the single fluid streams are ducted in a crosswise matter as is disclosed in EP1046867B1. A counter-current flow micro heat exchanger is a miniaturized plate heat exchanger in which the single fluid streams are ducted in a way that the inlets as well as the outlets of both fluids are in opposite direction to each other and therefore the fluid streams are running against each other, which is also described in EP1046867B1. A co-current flow micro heat exchanger is a miniaturized plate heat exchanger in which the single fluid streams are ducted in a way that the inlets as well as the outlets of both fluids are at the same direction of the device to each other and, therefore, the fluid streams are running in parallel which is described in EP1046867B1. An electrically powered parallel flow micro heat exchanger is a miniaturized heat exchanger where the heating or cooling energy is given by electrical elements (resistor heater cartridges, Peltier-Elements) such as described in e.g., EP1046867B1, EP1402589B1, EP1402589B1, the disclosures of which are hereby incorporated by reference.

Methods of using and examples of microreactors are further described in WO2011091962 and WO2011098240, the disclosures of which are hereby incorporated by reference.

The use of microreactors to make resistant dextrins has numerous benefits. The benefits of microreactors compared to large scale processes include, but are not limited to, a large-scale batch process can be replaced by a continuous flow process, the smaller devices need less space, fewer materials and less energy are required, shorter responses times and an enhanced system performance. Consequently, microreactors significantly intensify heat transfer, mass transport and diffusional flux per unit volume or unit area.

The flow guiding elements of the microreactor can be produced using 3D printing. Preferably, the flow guiding elements of the microreactor are manufactured from metal, ceramics, plastics, other inorganic materials, or combinations thereof.

The flow guiding elements can comprise a catalytically active material; optionally, wherein the microchannel structured flow guide elements further comprises a support material to which the catalytically active material, a corrosion protection material, an antifouling layer, or, a combination thereof; optionally, wherein the support material is carbon or silica. Preferably, the catalytic material is an acid such as any one of phosphoric acid, citric acid, malic acid, succinic acid, adipic acid, gluconic acid, tartaric acid, fumaric acid, or, a combination thereof. The flow guiding elements can be a device or devices for achieving a defined guidance of a volume of a flow of a fluid through a channel-shaped element, wherein in the channel shaped element microchannel structural flow guide elements are arranged for dividing the volume flow and for guidance of the resulting partial flows of fluids, and wherein the construction is arranged in such a way that the partial streams are guided such that they are brought into contact alternatively with the inner wall of the channel-shaped elements and with the other partial streams. Preferably, the cross section of the channel-shaped element is designed in a circular, circular-ring, elliptical or rectangular shape. Preferably, the flow guiding elements comprise or consist of a catalytically active material; optionally, wherein the microchannel structured flow guide elements further comprise a support material to which the catalytically active material is supported, optionally, wherein the support material is carbon or silica. Preferably, the catalytic material is an acid such as any one of phosphoric acid, citric acid, malic acid, succinic acid, adipic acid, gluconic acid, tartaric acid, fumaric acid, or, a combination thereof.

The microchannel structured flow guide elements can comprise or consist of a catalytically active material, a corrosion protection material, an antifouling layer or a combination thereof. Examples of corrosion protection materials include but are not limited to a zinc layer. Examples of an antifouling layer include but are not limited to antifouling paint. Optionally, the microchannel structured flow guide elements further comprise a support material to which the catalytically active material, a corrosion protection material, an antifouling layer, or, a combination thereof is supported, optionally, wherein the support material is carbon or silica.

The flow guiding elements of the microreactor can be fixedly installed: this ensures that constant contact with the channel wall or the other partial flows is ensured at defined surfaces.

Methods of using and examples of fluid guiding elements for use with microreactors are further described in EP3334993B1 and EP1525426B1, the disclosures of which are hereby incorporated by reference.

Preferably, the method does not comprise a flash evaporation drying step, more preferably, the method does not comprise a water reduction step.

Preferably, the method consists of passing the saccharide feed through the microreactor once.

Preferably, the method consists of passing the saccharide feed through the microreactor once and does not comprise a drying step.

Preferably, the method further includes one or more of the following steps: chromatography, hydrogenation, filtration (via ultra or membrane filtration), activated carbon treatment, decolourisation, electrolysis, ion exchange resins, or a combination thereof.

Advantageously, the method or producing the polysaccharide can form a polysaccharide wherein at least 80 weight % of the glucose and/or glucose oligomers have reacted by passing the saccharide feed through a microreactor once without the need to include a drying step in the method. The method therefore advantageously allows for a more compact reactor design, requires less equipment (e.g., no need for a reactor or a cross flow heat separator, a cyclone separator, a pump and/or a second microreactor). The costs are thus reduced.

### Method of Producing the Composition Comprising the Polysaccharide

Another aspect of the present invention relates to a method of making the polysaccharide in a composition. The method of making the polysaccharide in a composition comprises the steps:
(a) providing a polysaccharide;
(b) combining the polysaccharide with water to form a composition.

Water can be added to the polysaccharide until the composition comprises the polysaccharide at from 1 to 70 weight %, or from 3 to 60 weight %, or from 5 to 50 weight %.

Preferably, the composition comprises dry solids at from 40 to 90 weight %, or, from 45 to 80 weight %.

Preferably, at least 80 weight %, or at least 85 weight %, or at least 90 weight %, or at least 95 weight % of the polysaccharide has polymerised.

### The Polysaccharide and or Composition in a Food or Beverage Product

Another aspect of the present invention relates to the polysaccharide and/or composition comprising the polysaccharide in a food or beverage product.

The polysaccharide and/or composition comprising the polysaccharide can be used in a food or beverage product. Optionally, the food or beverage product also comprises bulking agents, such as sugar alcohols or maltodextrins; sweeteners, such as sucrose, HFCs, fructose and/or high intensity sweeteners.

The polysaccharide and/or composition comprising the polysaccharide can be used in a food or beverage product as a tenderizer or texturizer (for example to improve the crispness of a product), a humectant (for example to improve product shelf life and/or to produce a soft or moist texture), an agent that reduces water activity, replaces egg wash, improves sheen of a product, to replace fat in a product, to alter flour starch gelatinization temperature, to modify texture of the product and/or to enhance browning of a product.

The polysaccharide and/or composition may be present in a food or beverage product, or in a phase of the food or beverage product, which comprises at least 10 weight %, or, at least 20 weight %, or, at least 30 weight %, or, at least 50 weight % water. The polysaccharide and/or composition can also be present in a food or beverage product, or in a phase of the food or beverage food product, which is a dry mix to which a liquid, such as water, is added. Examples of dry mixes include, but not limited to powders for fruit beverages, protein beverages, meal replacements, milk, milk modifiers, batters, puddings, soups, gravies and sauces.

The polysaccharide and/or composition may be incorporated into a confectionary food product, which includes but is not limited to chocolate. Examples of the chocolate in which resistant dextrin can be incorporated includes but is not limited to milk chocolate, bittersweet chocolate, dark chocolate and white chocolate. Other ingredients present in the chocolate include, but are not limited to, sweeteners such as sugar and non-sugar sweeteners, cocoa liquor, cocoa butter, dairy ingredients, vegetable fats and/or emulsifiers.

The polysaccharide and/or composition may be incorporated into a confectionary coating food product. Other ingredients present in the confectionary coating food product include, but are not limited to, sweeteners, cocoa butter cocoa powder or cocoa butter equivalents, vegetable fats, emulsifiers and/or flavorings such as, but not limited to, yoghurt, strawberry, vanilla, white chocolate, mint, peanut butter and/or raspberry. The confectionary coating food product can be used in, but not limited to use in, baked goods.

The polysaccharide and/or composition may be incorporated into a chocolate filling food product. Examples of the chocolate filling food product includes a chocolate filling placed within a chocolate shell, and/or a chocolate filling within baked goods such as cake, brownies, cookie crisps, muffins, breads, sweet doughs, pastries, biscuits and/or cookies.

The polysaccharide and/or composition may be incorporated into a fatty spread food product. Examples of the fatty spread food product include, but are not limited to, nut-based spreads such as peanut butter, almond butter and cashew butter, sweetened nut spreads such as sweetened hazelnut spreads, milk-based spreads and/or chocolate-based spreads.

The polysaccharide and/or composition may be incorporated into sweet food products such as sweets and/or candy bars which include, but are not limited to, energy bars, snack bars, breakfast bars and/or protein bars.

The polysaccharide and/or composition may be incorporated into sugar glasses in the amorphous state. The sugar glasses can be, but are not limited to, used to adhere to baked goods and/or to form a film or coating which enhances the appearance of a baked good.

The polysaccharide and/or composition may be incorporated into a fermented beverage. The fermented beverage may contain ethanol, preferably no more than 50 weight %, or, no more than 15 weight %, or, no more than 10 weight %, or, no more than 8 weight % ethanol. The fermented beverage can be, but is not limited to, beer, such as ale or lager, cider, mead, wine, rice wine, sake, kombucha drink or a sauerkraut juice.

The polysaccharide and/or composition may be incorporated into a dairy product, which includes, but is not limited to, milk-drinks, cream, butter, yoghurt, cheese, custard, cottage cheese, cream cheese, curd, frozen dairy products such as frozen custard, frozen yogurt and ice-cream, gelato, powdered milk, evaporated milk, sour cream, soured milk, whey, whey protein or whipped cream.

Other possible food and/or beverage products the polysaccharide and/or composition can be incorporated into includes, but is not limited to, frozen dessert, chewing gum, centerfill confections, mediated confectionary, lozenges, tablets, pastilles, mints, standard mints, power mints, chewy sweets, hard sweets, boiled sweets, breath and oral care films or strips, candy canes, lollipops, gummies, jellies, wine gums, fudge, caramel, hard and soft panned goods, fruit snacks, toffee, taffy, liquorice, gelatin sweets, gum drops, jellybeans, nougats, fondants, meat analogue, bread, cake, cookies, crackers, extruded snacks, soup, fried food, pasta product, potato product, rice product, corn product, wheat product, dairy product, breakfast cereal, anhydrous coatings (for example, ice cream compound coating and chocolate), syrups, jams and jellies, beverages, clear-water, ready-to-drink beverages, protein beverages, toaster paninis, donuts, fillings, extruded and sheeted snacks, gelatin desserts, cheese, cheese sauces, liquid and dry coffee creamers, lower milk solids cheese, lower fat cheese, calorie reduced cheese, milk alternatives such as but not limited to nut-based milk alternatives and oat-based milk alternatives, smoothies, ice cream, shakes, cottage cheese, cottage cheese dressing, dairy desserts, edible and water-soluble films, dressings, creamers, icings, frostings, glazes, dry and moist pet food, tortillas, puffed snacks, corn chips, meat, fish, dried fruit, infant and toddler food, batters and/or breadings such as batters and breadings for meat.

Advantageously, the polysaccharide and/or composition are added to the food and/or beverage products to provide a source of soluble fibre. The polysaccharide and/or composition can, advantageously, increase the fibre content of the food and/or beverage products without damaging the flavour, mouth feel or texture of the resultant food and/or beverage product. The polysaccharide and/or composition can be added to the product and/or beverage optionally together with fructooligosaccharides, polydextrose, inulin, maltodextrin, resistant starch, starch, sucrose, and/or conventional corn syrup solids. The polysaccharide and/or composition can be used as a replacement for from 0 to 100 weight % of the fibre in the food and/or beverage product. Thus, the resultant food or beverage product contains from 0 to 100% less sugar.

Advantageously, the polysaccharide and/or composition are to the food and/or beverage product to act as a sweetener. The polysaccharide and/or composition are suitable for complete or partial replacement with other sweeteners such as high fructose corn syrup, fructose, dextrose, regular corn syrup, corn syrup solids, sweet potatoes such as Brazzein and/or Thaumatin, tapioca syrup, oat syrup, rice syrup and/or pea syrup. Upon replacing the sweetener with the polysaccharide and/or composition, the sugar level is reduced but the mouthfeel and flavour remain the same, or substantially the same. The polysaccharide and/or composition can be used as a replacement for from 0 to 100 weight % of the sweetener in the food and/or beverage product.

Advantageously, the polysaccharide and/or composition are added to the food and/or beverage product to act as a bulking agent. The polysaccharide and/or composition are suitable for complete or partial replacement with other bulking agents and can therefore replace fat, flour, sugar alcohols, maltodextrins and/or other bulking agents present. Upon replacing the bulking agent with the polysaccharide and/or composition, the caloric level is reduced, nutritional profile of the product improved and the mouthfeel and flavour remain the same, or substantially the same. The polysaccharide and/or composition are be used as a replacement for from 0 to 100 weight % of the bulking agent in the food and/or beverage product.

Advantageously, the polysaccharide and/or composition are added to the food and/or beverage product to control or improve the blood glucose concentrations in humans and animals that suffer from diabetes. When the human or animal digest the food and/or beverage containing the polysaccharides and/or composition, the polysaccharide and/or composition can cause a more moderate relative glycaemic response in the blood steam.

### Method of Producing the Polysaccharide and or Composition Comprising the Polysaccharide in a Food or Beverage Product

Another aspect of the present invention relates to a method of making the polysaccharides and/or composition comprising the polysaccharide present in a food or beverage product. The method of making the food or beverage product comprises the steps:
(a) providing the polysaccharides and/or composition comprising the polysaccharide; and
(b) combining the polysaccharides and/or composition comprising the polysaccharide with at least one food or beverage product.

### EXAMPLES

The following are non-limiting examples that discuss, with reference to tables, the advantages of the present invention. The examples set forth herein are merely examples among other possible examples.

### Example 1: Making the Polysaccharides

In this non-limiting example of the present invention, a polysaccharide according to the present invention was made.

In this example, a saccharide feed was made by combining glucose monomers and glucose oligomers with water. The glucose monomers and glucose oligomers were combined with sorbitol (C*Sorbidex P16656) and citric acid at a weight ratio of 90:10:1 respectively. This dry blend was then mixed with water at 95° C. to obtain a saccharide feed containing 80 weight % solids content, with the remainder being water.

The saccharide feed was then pumped at a rate of 20 ml/min to a microreactor comprising three flow guiding elements. The microreactor operated at a temperature of 220 to 235° C. and a pressure of from 2 to 5 bar. The saccharide feed had a residence time in the microreactor of 70 seconds or less.

Whilst in the microreactor, 80 weight % of the glucose monomers and glucose oligomers reacted to form a polysaccharide having a DPn content, wherein n is at least 3.

### Example 2: Making the Polysaccharides with a Lower Weight % of Initial Dry Solids

In this non-limiting example of the present invention, a polysaccharide according to the present invention was made.

In this example, a saccharide feed was made by combining glucose monomers and glucose oligomers with water. The glucose monomers and glucose oligomers were combined with sorbitol (C*Sorbidex P16656) and citric acid at a weight ratio of 90:10:1 respectively. This dry blend was then mixed with water at 95° C. to obtain a saccharide feed containing 60 weight % solids content, with the remainder being water.

The saccharide feed was then pumped at a rate of 20 ml/min to a microreactor comprising three flow guiding elements. The microreactor operated at a temperature of 220 to 235° C. and a pressure of from 2 to 5 bar. The saccharide feed had a residence time in the microreactor of 70 seconds or less.

Whilst in the microreactor, 60 weight % of the glucose monomers and glucose oligomers reacted to form a polysaccharide having a DPn content, wherein n is at least 3.

### Example 3: Measuring the DP Content of the Polysaccharides

In this non-limiting example of the present invention, the degree of polymerisation (DP) content of the polysaccharide according to the present invention was measured.

In this example, a first saccharide feed was made by combining with sorbitol (C*Sorbidex P16656) and citric acid at a weight ratio of 90:10:1 respectively. This dry blend was then mixed with water at 95° C. to obtain a first saccharide feed containing 71.3 weight % solids content, with the remainder being water. The first saccharide feed was then pumped at a rate of 20 ml/min to a microreactor comprising three flow guiding elements. The microreactor operated at a temperature of 220 to 235° C. and a pressure of from 2 to 5 bar. The first saccharide feed had a residence time in the microreactor of 70 seconds or less. Whilst in the microreactor, 71.3 weight % of the glucose monomers and glucose oligomers reacted to form a polysaccharide (called polysaccharide A) having a DPn content.

In this example, a second saccharide feed was made by combining glucose monomers and glucose oligomers with sorbitol (C*Sorbidex P16656) and citric acid at a weight ratio of 90:10:1 respectively. This dry blend was then mixed with water at 95° C. to obtain a second saccharide feed containing 71.3 weight % solids content, with the remainder being water. The second saccharide feed was then pumped at a rate of 20 ml/min to a microreactor comprising three flow guiding elements. The microreactor operated at a temperature of 220 to 235° C. and a pressure of from 2 to 5 bar. The first saccharide feed had a residence time in the microreactor of 70 seconds or less. Whilst in the microreactor, 71.3 weight % of the glucose monomers and glucose oligomers reacted to form a polysaccharide (called polysaccharide B) having a DPn content.

The DPn content of polysaccharide A and polysaccharide B was then analysed with an Ultimate 3000 three channels pump HPLC coupled with a Q-exactive Focus mass spectrometer from ThermoFisher.

The Ultimate 3000 three channels pump HPLC comprised peek tubing and was used with a mobile phase formed of 0.5 mM ammonium formate in MilliQ water/acetonitrile at 50:50 volume to volume.

The temperature of the column was not controlled. The gradient used was isocratic. The column was washed with 0.5 mM ammonium formate in MilliQ water/acetonitrile at 50:50 volume to volume prior to data collection.

Water was added to each of the polysaccharides separately to form two separate compositions comprising 71.3 weight % of either polysaccharide A or polysaccharide B, with the remainder being water.

The compositions were then separately added to the Ultimate 3000 three channels pump HPLC with an autosampler and analysed individually. The temperature of the autosampler was 10° C. The autosampler provided an injection volume of 5 μl of the composition into the Ultimate 3000 three channels pump HPLC. Inside the Ultimate 3000 three channels pump HPLC, the composition had a flow rate of 0.3 ml/min. The Ultimate 3000 three channels pump HPLC made scans of the composition in negative polarity. The run time in the Ultimate 3000 three channels pump HPLC was 0.5 minutes.

The Q-exactive Focus mass spectrometer analysed the composition in triplets. The Q-exactive Focus mass spectrometer operated in MS scan mode, with a MS scan of 100-2500 uma and a peak width of 0.2 min.

A comparative sample was analysed and has been labelled comparative polysaccharide in Table 1.

The comparative sample is the polysaccharide from Example 3 in WO2011091962A1, the disclosure of which is hereby incorporated by reference. The comparative sample was mixed with water at 80° C. to form a composition comprised 72 weight % of the polysaccharide, with the remainder being water.

The DP content of the comparative polysaccharide was measured using the same method used to determine the DP content of polysaccharide A and polysaccharide B.

The results of the experiments are set out in Table 1.

TABLE 1
The DPn content of the polysaccharide according to
the present invention, and a comparative example.

| Material | DP | DP value |
|---|---|---|
| Polysaccharide A | DP2 | 8.4 |
| | DP3 | 8.2 |
| | DP4 | 7.1 |
| | DP5 | 6.3 |
| | DP6 | 5.4 |
| | DP7 | 4.4 |
| | DP8+ | 48.0 |
| | Other | 12.2 |
| Polysaccharide B | DP2 | 8.4 |
| | DP3 | 8.1 |
| | DP4 | 7.2 |
| | DP5 | 6.2 |
| | DP6 | 5.4 |
| | DP7 | 4.5 |
| | DP8+ | 47.8 |
| | Other | 12.4 |
| Comparative polysaccharide | DP2 | 5.9 |
| | DP3 | 6.5 |
| | DP4 | 6.1 |
| | DP5 | 5.7 |
| | DP6 | 4.9 |
| | DP7 | 4.5 |
| | DP8+ | 56.6 |
| | Other | 9.8 |

The “Other” content in the above table relates to any dextrose and other unknown impurities present in the sample.

Advantageously, the polysaccharide according to the present invention has a higher distribution of small molecules present. This advantageously reduces the viscosity of the polysaccharide, resulting in a polysaccharide which is easier to process.

### Example 4: Measuring the Fibre Content of the Polysaccharide and Composition

In this non-limiting example of the present invention, the fibre content of the polysaccharide was measured.

The polysaccharide was made via the method set out in Example 1. The dietary fibre content of the polysaccharide was then measured using the well-known method AOAC 2009.01.

A composition comprising the polysaccharide made via the method set out in Example 1 was then made. The composition comprised 49.7 weight % polysaccharide, with the remainder being water.

The dietary fibre content of the composition was then measured using the well-known method AOAC 2009.01.

A comparative sample was analysed. The comparative sample is the polysaccharide from Example 3 in WO2011091962A1, the disclosure of which is hereby incorporated by reference. The fibre content of the polysaccharide was then measured using the well-known method AOAC 2009.01.

The results of the dietary fibre analysis are set out in Table 2.

TABLE 2
The dietary fibre content of the polysaccharide and
composition, according to the present invention.

| | Dietary fibre |
|---|---|
| Material | content (weight %) |
| Polysaccharide (according to the present | 77 |
| invention) | |
| Composition (comprising the polysaccharide | 38.1 |
| according to the present invention) | |
| Polysaccharide (according to Example 3 in | 86 |
| WO2011091962A1) | |

As described in Example 3 of WO2011091962A1, the disclosure of which is hereby incorporated by reference, to produce a similar polysaccharide to the polysaccharide according to the present invention, the method required at least 80 weight % dry solids in the starting product. The resultant polysaccharide has a fibre content of 86 weight %.

However, the present invention advantageously does not require a starting product comprising at least 80 weight % dry solids in the starting product. The starting product can comprise a much lower dry solids content. The resultant polysaccharide has a fibre content of 77 weight %. Advantageously, the fibre content of the polysaccharide formed by the present invention is not dependent on the dry solids content of the starting material.

A further advantage of the present invention is that a polysaccharide having a similar high fibre content to the two-step process described in WO2011091962A1, the disclosure of which is hereby incorporated by reference, can be obtained via a simpler one-step process, thereby resulting in a more efficient and more inexpensive method.

### Example 5: A Composition According to the Present Invention

In this non-limiting example, a polysaccharide composition comprising the polysaccharide according to the present invention was made.

In this example, a polysaccharide having a fibre content of 38.1 weight % was made according to the method set out in Example 1. The polysaccharide was then added to water to form a composition. The polysaccharide was present in the water at 49.7 weight %.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

Although certain example aspects of the invention have been described, the scope of the appended claims is not intended to be limited solely to these examples. The claims are to be construed literally, purposively, and/or to encompass equivalents.

1. A polysaccharide comprising:
from 5 to 35 weight % of 1,2-glycosidic linkages and 1,3-glycosidic linkages,
from 25 to 35 weight % of 1,4-glycosidic linkages, and
from 35 to 45 weight % of 1,6-glycosidic linkages,
wherein the polysaccharide has a DP1 and a DP2 content, wherein DP1 and DP2 are present at a combined weight % of from 17.5 weight % to 25 weight %.

2.-15. (canceled)

16. The polysaccharide of claim 1, wherein DP1 and DP2 are present at a combined weight % of 17.5 weight % to 22.5 weight wherein the weight % is measured on dry basis.

17. A composition comprising:
the polysaccharide of claim 1; and
water;
wherein the composition comprises dry solids at from 40 to 90 weight %.

18. The polysaccharide of claim 1, wherein the polysaccharide has a DP3 to DP7 content from 29 to 35 weight %.

19. The polysaccharide of claim 1, wherein the polysaccharide comprises glucose monomers and glucose oligomers at a total concentration of 50 to 100 weight %.

20. The polysaccharide of claim 1, wherein the polysaccharide has a DP1 content of from 2 to 5 weight %.

21. The polysaccharide of claim 1, wherein the polysaccharide has a DP8+content less than 50 weight %.

22. A method for making the polysaccharide of claim 1, the method comprising:
(a) providing a saccharide feed comprising glucose monomers, glucose oligomers, or combinations thereof;
(b) providing at least one acid catalyst;
(c) providing a microreactor comprising one or more flow guiding elements; and
(d) passing the saccharide feed through the microreactor in the presence of the acid catalyst until at least 80 weight % of the glucose monomers and glucose oligomers in the saccharide feed have reacted to form a polysaccharide having a DPn content, wherein n is at least 3.

23. The method of claim 22, wherein the saccharide feed comprises a dry substance content of less than 80 weight %; and
wherein the remaining weight % of the saccharide feed is water.

24. The method of claim 22,
wherein the glucose monomers, glucose oligomers, or combination thereof are sourced from a glucose syrup or a maltodextrin;
(i) wherein the glucose syrup has a dextrose equivalent (DE) of 20 or greater; or,
(ii) wherein the maltodextrin has a dextrose equivalent (DE) of from 3 to 20.

25. The method of claim 22, wherein the saccharide feed comprises a polyol selected from the group consisting of glycerol, erythritol, threitol, arabinitol, xylitol, ribitol, allitol, altritol, gulitol, galactitol, mannitol, sorbitol, talitol, maltitol, isomaltitol, isomalt, lactitol, and combinations thereof.

26. The method of claim 22, wherein the acid catalyst is selected from the group consisting of phosphoric acid, citric acid, malic acid, succinic acid, adipic acid, gluconic acid, tartaric acid, fumaric acid, and combinations thereof.

27. The method of claim 22, wherein the microreactor comprises a plurality of flow guiding elements; and
wherein the plurality of flow guiding elements are arranged (i) in series, (ii) in parallel, or (iii) a portion of the plurality are in a first series, a portion of the plurality are in a second series and the first series and the second series are in parallel.

28. The method of claim 18, wherein:
the flow guiding element is a device for achieving a defined guidance of a volume of a flow of a fluid through a channel-shaped element;
wherein in the channel shaped element microchannel structural flow guide elements are arranged for dividing the volume flow and for guidance of the resulting partial flows of fluids; and
wherein the construction is arranged in such a way that the partial streams are guided such that they are brought into contact alternatively with the inner wall of the channel-shaped elements and with the other partial streams.

29. The method of claim 28, wherein the cross section of the channel-shaped element is designed in a circular, circular-ring, elliptical, or, rectangular shape.

30. The method of claim 22, wherein the microchannel structured flow guide elements comprise a catalytically active material, a corrosion protection material, an antifouling layer, or a combination thereof.

31. The method of claim 22, wherein the microreactor operates at a temperature from 200 to 240° C.

32. The method of claim 22, wherein the saccharide feed has a residence time in the microreactor of 60 seconds or less.

33. A food product comprising the polysaccharide of claim 1.

34. The food product of claim 29, wherein the food product is a dairy food product or a confectionary food product.
